(19) United States
(12) Patent Application Publication
(10) Pub. No.: US 2013/0141467 A1
(43) Pub. Date: Jun. 6, 2013

(54) DATA DISPLAY METHOD AND MOBILE DEVICE ADAPTED THERETO

(71) Applicant: Samsung Electronics Co., Ltd., Gyeonggi-do (KR)

(72) Inventors: Kyunghoon HAN, Seoul (KR); Sungho PARK, Seoul (KR); Youngsun SHIN, Gyeonggi-do (KR); Chaekyung LEE, Seoul (KR)

(73) Assignee: Samsung Electronics Co., Ltd., Gyeonggi-do (KR)

(21) Appl. No.: 13/688,652

(22) Filed: Nov. 29, 2012

(30) Foreign Application Priority Data
Dec. 2, 2011 (KR) 10-2011-0128230

(51) Int. Cl. G06T 3/40; G06T 1/00; G06F 3/0488

(52) U.S. Cl. CPC G06T 3/40; G06F 3/0488; G06T 1/00
USPC 345/660; 345/501; 345/173

(57) ABSTRACT

A data display method and a mobile device adapted thereto includes: displaying one or more filtering conditions on a condition display area and one or more items of media data on a data display area in a data display mode; determining whether an event occurs on the condition display area or the data display area; identifying, if an event occurred on the condition display area, information regarding a filtering condition as filtering condition information corresponding to the event; and displaying media data according to the identified filtering condition information. Since the media data can be displayed, in real-time, on the mobile device according to the filtering conditions, the mobile device user can feel an interest in setting the filtering conditions.

### CLAIM OF PRIORITY

This application claims, pursuant to 35 U.S.C. §119(a), priority to and the benefit of the earlier filing date of a Korean patent application filed on Dec. 2, 2011 in the Korean Intellectual Property Office and assigned Serial No. 10-2011-0128230, the entire disclosure of which is hereby incorporated by reference.

### BACKGROUND OF THE INVENTION

1. Field of the Invention

This invention relates to a method for displaying data according to selected filtering conditions and a mobile device adapted thereto.

2. Description of the Related Art

Developments in science and technology have led to an increase in the types of mobile devices. Mobile devices have also developed to store a large amount of data, or information and detailed information. Detailed information refers to the format of data, the creation date of data, the size of data, the location where data is stored, tag information stored by the user, etc.

The detailed information may be used to search for data. That is, if a mobile device user inputs tag information, date, etc., in text, or sets a data filtering condition by selecting a type of media/content, the mobile device searches for and displays the data according to the tag information or the set condition. For example, if a mobile device user inputs a creation date of an image or information regarding a face in the image or a place where the image is created, or sets filtering conditions that are displayed, in an image display mode, the mobile device displays thumbnail images corresponding to the user's inputs or the user's set filtering conditions.

Systems in the prior art are implemented in such a way that a step for inputting or selecting a filtering condition in order to search for corresponding data and a step for displaying the data are performed separately and step by step. That is, at the step for inputting a filtering condition, systems in the prior art cannot detect which data is to be filtered. Therefore, if users are not satisfied with the results obtained via the filtering process, they must go back to the previous step for correcting the previously input filtering conditions and re-input or re-select filtering conditions. This inconveniences users.

Systems in the prior art are disadvantageous in that a number of places, a number of people, a number of dates, etc. cannot be selected via filtering conditions or complicated processes are required to input them. That is, although systems in the prior art can display corresponding data by selecting a filtering condition at one time, they cause users to have difficulty selecting filtering conditions to display a variety of data. In addition, although systems in the prior art may allow for the setting of a number of conditions in order to perform a filtering process with respect to data, they require the setting of additional conditions, such as inputting texts, checking items, etc., before performing the search process.

### SUMMARY OF THE INVENTION

The present invention has been made in view of the above problems, and provides a method for displaying data according to selected filtering conditions, and a mobile device adapted thereto.

In accordance with an exemplary embodiment of the present invention, the present invention provides a method for displaying data in a mobile device, including: displaying one or more filtering conditions on a condition display area and one or more items of media data on a data display area in a data display mode; determining whether an event occurs on the condition display area or the data display area; identifying, if an event occurred on the condition display area, information regarding a filtering condition, as filtering condition information, corresponding to the event; and displaying at least one thumbnail image corresponding to one or more items of media data filtered according to the identified filtering condition information.

In accordance with another exemplary embodiment of the present invention, the present invention provides a mobile device including a touch screen and a controller. The touch screen includes a display unit and a touch sensor. The display unit displays one or more filtering conditions on a condition display area and one or more items of media data on a data display area in a data display mode. The touch sensor senses the presence of events that occur on the condition display area or the data display area. The controller identifies an area on the touch screen where an event occurs. The controller controls, if the area where the event occurred is the condition display area, the display unit to display at least one thumbnail image corresponding to one or more items of media data corresponding to the filtering condition information that is altered according to the event.

### BRIEF DESCRIPTION OF THE DRAWINGS

The features and advantages of the invention will become more apparent from the following detailed description viewed in conjunction with the accompanying drawings, in which:

FIG. 1 illustrates a schematic block diagram of a mobile device according to an exemplary embodiment of the present invention;

FIGS. 2A to 2C illustrate screens where a mobile device operates in a data display mode according to a first exemplary embodiment of the present invention;

FIGS. 3A to 3D illustrate screens where a mobile device operates in a data display mode according to the first exemplary embodiment of the present invention, according to the occurrence of input events;

FIG. 4 illustrates a screen where a mobile device operates in a data display mode according to a second exemplary embodiment of the present invention;

FIG. 5 illustrates a screen where a mobile device operates in a data display mode according to the second exemplary embodiment of the present invention, where a number of filtering conditions are selected;

FIG. 6 illustrates a screen where a mobile device operates in a data display mode according to a third exemplary embodiment of the present invention;

FIG. 7 illustrates a screen where a mobile device operates in a data display mode according to a fourth exemplary embodiment of the present invention;

FIG. 8 illustrates a screen where a mobile device operates in a data display mode according to a fifth exemplary embodiment of the present invention, where an additional filtering condition is selected;

FIG. 9 illustrates a screen where a mobile device operates in a data display mode according to a sixth exemplary embodiment of the present invention;

FIG. 10 illustrates a flow chart that describes a method for displaying data, according to the exemplary embodiments of the present invention; and

FIG. 11 illustrates a flow chart that describes a method for identifying filtering conditions altered according to the occurrence of events, according to the exemplary embodiments of the present invention.

### DETAILED DESCRIPTION OF THE INVENTION

Hereinafter, preferred embodiments of the present invention are described in detail with reference to the accompanying drawings. The same reference numbers are used throughout the drawings to refer to the same or similar parts. Detailed descriptions of well-known functions and structures incorporated herein may be omitted to avoid obscuring the subject matter of the invention. The terms or words described in the present description and the claims should not be limited by a general or lexical meaning, instead should be analyzed as a meaning and a concept through which the inventor defines and describes the invention at his most effort, to comply with the idea of the invention. Therefore, one skilled in the art will understand that the embodiments disclosed in the description and configurations illustrated in the drawings are only preferred embodiments, instead there may be various modifications, alterations, and equivalents thereof to replace the embodiments at the time of filing this application. Furthermore, although the drawings represent exemplary embodiments of the invention, the drawings are not necessarily to scale and certain features may be exaggerated or omitted in order to more clearly illustrate and explain the present invention.

Among the terms set forth herein, a terminal refers to any kind of device capable of processing data which is transmitted or received to or from any external entity. The terminal may display icons or menus on a screen to which stored data and various executable functions are assigned or mapped. The terminal may include a computer, a notebook, a tablet PC, a mobile device, and the like.

Among the terms set forth herein, a screen refers to a display or other output devices which visually display information to the user, and which optionally are capable of receiving and electronically processing tactile inputs from a user using a stylo, a finger of the user, or other techniques for conveying a user selection from the user to the output devices.

Among the terms set forth herein, an icon refers to a graphical element such as a figure or a symbol displayed on the screen of the device such that a user can easily select a desired function or data. In particular, each icon has a mapping relation with any function being executable in the device or with any data stored in the device and is used for processing functions or selecting data in the device. When a user selects one of the displayed icons, the device identifies a particular function or data associated with the selected icon. Then the device executes the identified function or displays the identified data.

Among terms set forth herein, data refers to any kind of information processed by the device, including text and/or images received from any external entities, messages transmitted or received, and information created when a specific function is executed by the device.

The term ‘a mobile device/mobile devices’ refers to an information processing system/systems that can process data transmitted from external systems or data created by the user. Examples of the mobile devices are computers, laptop computers, tablet PCs, smart phones, etc.

The term ‘media data’ refers to data that can be processed in the mobile devices, e.g., still images, videos, voice data, messages, document data, etc.

The mobile devices allow users to set filtering conditions, such as place, time, person, service channel, etc., or lists or ranges thereof, via an intuitive zooming-in/out event or a moving event, and to display the corresponding media data and to set filtering conditions on one screen, in real-time. That is, the mobile devices allow users to set filtering conditions to search for corresponding media data without executing a search process or an additional condition selecting process, and accordingly, to immediately display the corresponding media data.

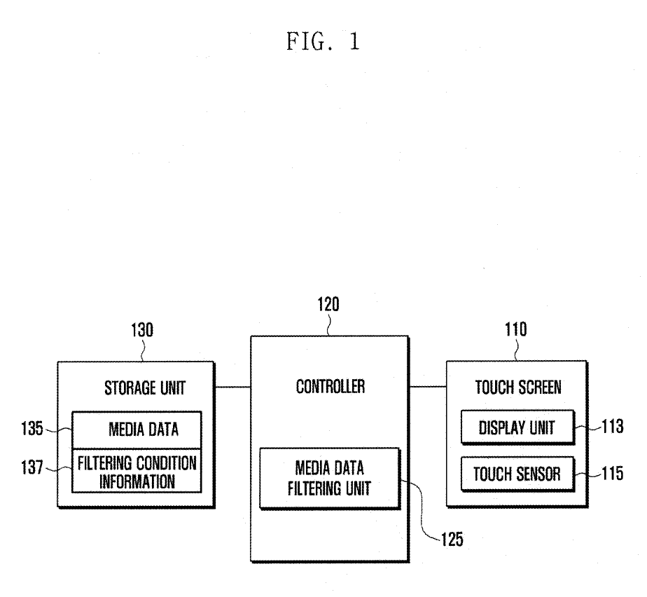

FIG. 1 illustrates a schematic block diagram of a mobile device according to an exemplary embodiment of the present invention.

Referring to FIG. 1, the mobile device includes a touch screen 110, a controller 120, and a storage unit 130.

The touch screen 110 includes a display unit 113 and a touch sensor 115. The display unit 113 displays screen data related to the states and operations of the mobile device. When the mobile device operates in a data display mode to display the stored media data on the display unit 113, the display unit 113 displays a data display area for displaying thumbnail images corresponding to the media data to be displayed and a condition display area for displaying filtering condition information to apply a filtering process to the media data.

The data display mode refers to a mode where the mobile device displays the stored media data according to the filtering condition information. Examples of the data display mode includes an image display mode where videos and still images such as photographs, etc., are displayed, a text data display mode where text data, such as documents, etc. are displayed, a message display mode where transmitted/received messages are displayed, etc.

The media data is displayed, as thumbnail images, on the data display area of the display unit 113, together with detailed information regarding the media data, in a data display mode. In addition, the filtering condition information is also displayed on the condition display area of the display unit 113 in order to apply the filtering process to the media data displayed on the data display area. The detailed information includes information regarding a location where media data is created, the creation date of the media data, information regarding another user included in the media data, and information regarding a service channel through which the media data is transmitted or received.

The filtering condition information refers to information to perform a filtering process by the media data sub-divided based on the detailed information. For example, in an image display mode where the media data is displayed according to the location information, the filtering condition information may include the name of a local area corresponding to a location, the coordinates of the location, etc. In an image display mode where media data is displayed according to time information when the media data is created, e.g., by month, the filtering condition information may be by month.

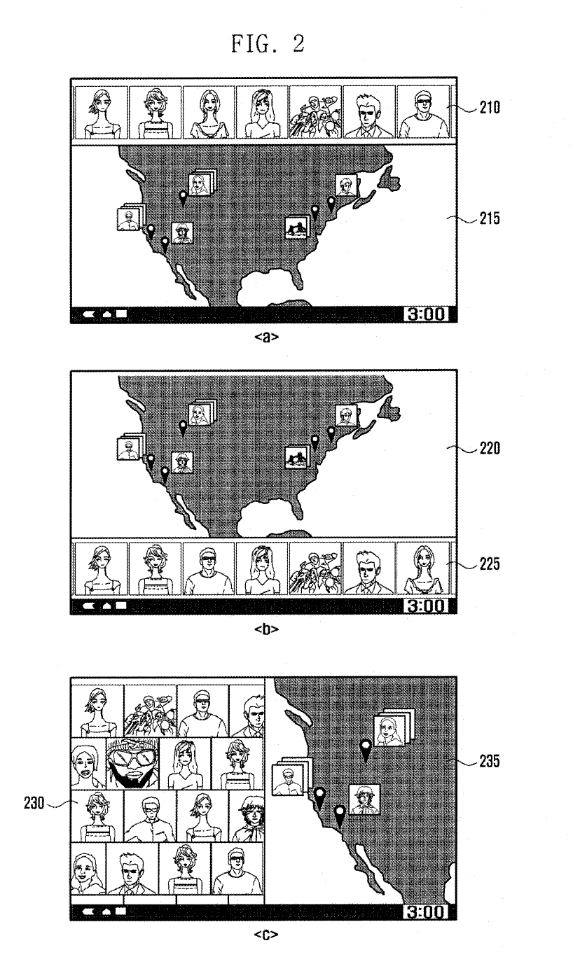

The display unit 113 alters the condition display area according to the presence of events under the control of the controller 120. The display unit 113 also alters the location where the filtering condition information is located according to the alteration of the condition display area. The display unit 113 performs a filtering process with respect to the thumbnail images displayed on the data display area, according to the filtering condition information, altered in the condition display area, under the control of the controller 120, and displays the filtered thumbnail images. The filtering process with respect to the thumbnail images, displayed on the data display area, according to the events that occurred in the condition display area, will be described in greater detail, referring to FIGS. 2 to 9.

The touch sensor 115 is installed onto or included in the display unit 113, and senses the presence of touch events that occur, according to the contact or release of objects, on the display unit 113. When the touch sensor 115 senses the presence of an event on the display unit 113, the sensor 115 detects the coordinates, generates corresponding signals, and transfers the signals corresponding thereto to the controller 120. The display unit 113 is designed in such a way that virtual grids are used and optionally displayed, and the crossing points have respective coordinates, so that the touch sensor 115 can sense coordinates of an event that occurs on the display unit 113, via the virtual grids. Therefore, if an event occurs on the display unit 113, the touch sensor 115 senses the point of intersection on the virtual grids and transfers the coordinates to the controller 120. The controller 120 detects the direction, speed, etc. of the event and the area where the event occurred, via the received coordinates.

The controller 120 controls the states and operations of the components in the mobile device. The controller 120 controls the display unit 113 to display the media data on the data display area and to display the filtering condition, applied to a filtering process to the media data, on the condition display area, respectively, in a data display mode.

The controller 120 alters the condition display area according to the events that occurred. The controller 120 identifies the filtering condition information displayed on the altered condition display area. The controller 120 includes a media data filtering unit 125 which performs a filtering process with respect to the thumbnail images displayed on the data display area according to the identified filtering condition information, and re-displays the thumbnail images.

The media data filtering unit 125 identifies a type of event that occurs on the touch screen 110 and the region where the event occurs. The media data filtering unit 125 may alter the filtering condition information, displayed on the condition display area, according to the identified event. If the media data filtering unit 125 ascertains that the area where the event occurred is in the condition display area, the media data filtering unit 125 can detect the type of event.

Examples of the event include a condition selecting event for selecting one piece of the displayed filtering condition information, a zooming-in/out event or a moving event for altering and displaying the condition display area, an event for selecting a number of pieces of filtering condition information, etc. For example, if an event occurs in an area of a condition display area where a particular piece of filtering condition information is displayed, by a tap gesture in which objects such as a user's finger or a stylus pen touches on and is released from the touch screen 110, the media data filtering unit 125 can identify the event as a condition selecting event.

When two touches are sensed in the condition display area on the touch screen 110 and the touched points are moving closer to each other, the media data filtering unit 125 identifies the touches as an event for selecting a zooming-out function. On the contrary, when the touched two points are moving apart from each other, the media data filtering unit 125 identifies the touches as an event for selecting a zooming-in function. Alternatively, if the zooming-in/out function is selected via menus, the media data filtering unit 125 identifies the selection as an event for selecting the zooming-in/out function.

When a touch is sensed in the condition display area on the touch screen 110 and moves in a certain direction, the media data filtering unit 125 identifies the touch as a moving event. If a touch is released from the condition display area where a number of pieces of filtering condition information are displayed, the media data filtering unit 125 identifies the touch as an event for selecting such pieces.

The media data filtering unit 125 controls the display unit 113 to alter and display the condition display area according to types of events that occurred. After that, the media data filtering unit 125 identifies the filtering condition information located in the altered condition display area.

The controller 120 performs a filtering process with respect to the media data, displayed on the data display area of the display unit 113, using the filtering condition information identified by the media data filtering unit 125, and then re-displays the media data.

If an event occurs in the data display area on the touch screen 110, the controller 120 identifies a thumbnail image to which the event is mapped. The controller 120 controls the display unit 113 to display the media data, corresponding to the identified thumbnail image, in the entire screen. On the contrary, if an event occurs in an area other than the data display area, the controller 120 executes a corresponding function mapped to the area. For example, if an event occurs in an area to which a menu for altering filtering condition information or adding additional filtering conditions thereto is mapped or an area to which a menu for executing another function is mapped, the controller 120 executes a function corresponding to the menu where the event occurred.

The storage unit 130 stores a number of application programs, including applications, applets, or apps, installed in the mobile device, and stores the media data 135 created when the applications are executed. The storage unit 130 stores the media data 135 and filtering condition information 137 executed with respect to the media data 135. The filtering condition information 137 is used to sub-divide thumbnail images of the media data 135, displayed on the data display area, according to the detailed information, and to perform a filtering process thereto. For example, if thumbnail images of the media data 135 are displayed on the data display area according to information regarding groups of other users, the filtering condition information 137 may be information regarding other users included in the information regarding the respective groups.

As described above, in order to search for media data stored in the mobile device, the user can set filtering conditions, such as places, a time, a person, service channels, etc., using intuitive methods, such as a zooming-in/out process, a movement process, etc. In such cases, the mobile device can search the media data according to the set filtering conditions and provide the search results to the user, in real-time, on the currently displayed screen, without switching the screen; for example, to a separate filter screen as in the prior art. Therefore, the filtering process can be simply executed with respect to the media data and the user can immediately, easily recognize the result.

Although the exemplary embodiments of the present invention are implemented in such a way that the touch screen 110 senses the presence of events, it should be understood that the invention is not limited to the exemplary embodiments. If mobile devices are equipped with physical keypads, such keypads can alter filtering condition information, displayed on the condition display area, according to the events that occurred, and can display corresponding thumbnail images. For example, the condition display area may be selected via direction keys, etc. The presence of events for executing a zooming-in/out function may be sensed according to the type or the input time of the pressing of direction keys. The presence of an event for selecting a moving function may be sensed according to types of direction keys which are pressed. In addition, the mobile device may be further equipped with components corresponding to additional functions as well as the components described above. Examples of the additional components are a communication unit for transmitting/receiving data between the mobile device and the external systems, a camera module, a digital multimedia broadcast (DBM) receiver for receiving digital broadcasts, a short-range wireless communication module, etc.

FIGS. 2A to 2C illustrate screens where a mobile device operates in a data display mode according to a first exemplary embodiment of the present invention.

As shown in FIGS. 2A to 2C, the display unit 113 displays two areas, in one of which one or more thumbnail images corresponding to the media data 135 stored in the mobile device are displayed. The area showing thumbnail images is hereinafter called a data display area, such as, for example, the data display area 210 in FIG. 2A, the data display area 225 in FIG. 2B or the data display area 230 in FIG. 2C.

The other area displays one or more pieces of filtering condition information 137 for searching for data in the mobile device, and is hereinafter called a condition display area, such as, for example, the condition display area 215 in FIG. 2A, the condition display area 220 in FIG. 2B, or the condition display area 235 in FIG. 2C. The filtering condition information 137 displayed on the condition display areas 215, 220 and 235 is used to perform a filtering process with respect to the media data 135.

As shown in FIG. 2A, the screen of the display unit 113 may be configured to show the data display area 210 on an upper portion and the condition display area 215 on a lower portion. As shown in FIG. 2B, the screen of the display unit 113 may be configured to show the condition display area 220 on the upper portion and the data display area 225 on the lower portion. As shown in FIG. 2C, the screen of the display unit 113 may be configured to show data the display area 230 on a left portion and the condition display area 235 on a right portion or, alternatively, the data display area 230 on the right portion and the condition display area 235 on the left portion.

The data display areas 210, 225 and 230 and the condition display areas 215, 220, and 235 may be arranged on the screen according to the user's customized setting or the manufacturers' designs, for example, default settings which the user may alter, customize, and save. In addition, the ratio of areas of the data display areas 210, 225 and 230 to the condition display areas 215, 220 and 235, respectively, may also be set according to the user's setting or the manufacturers' designs, such as a default ratio.

As described above, although the exemplary embodiment of the present invention is implemented in such a way that the filtering condition information is displayed on, for example, a map as shown in FIGS. 2A-2C, it should be understood that the present invention is not limited to the exemplary embodiment. That is, the filtering condition information 137 may be displayed on a variety of designs according to types of filtering conditions. For example, if the filtering condition information 137 is time information, such filtering condition information may be displayed in a format of a timeline. Alternatively, if the filtering condition information 137 is group information grouping information regarding other users, the information regarding the other users may be displayed according to the groups. In addition, the condition display area showing the filtering condition information 137 may be altered or re-displayed according to the user's created events.

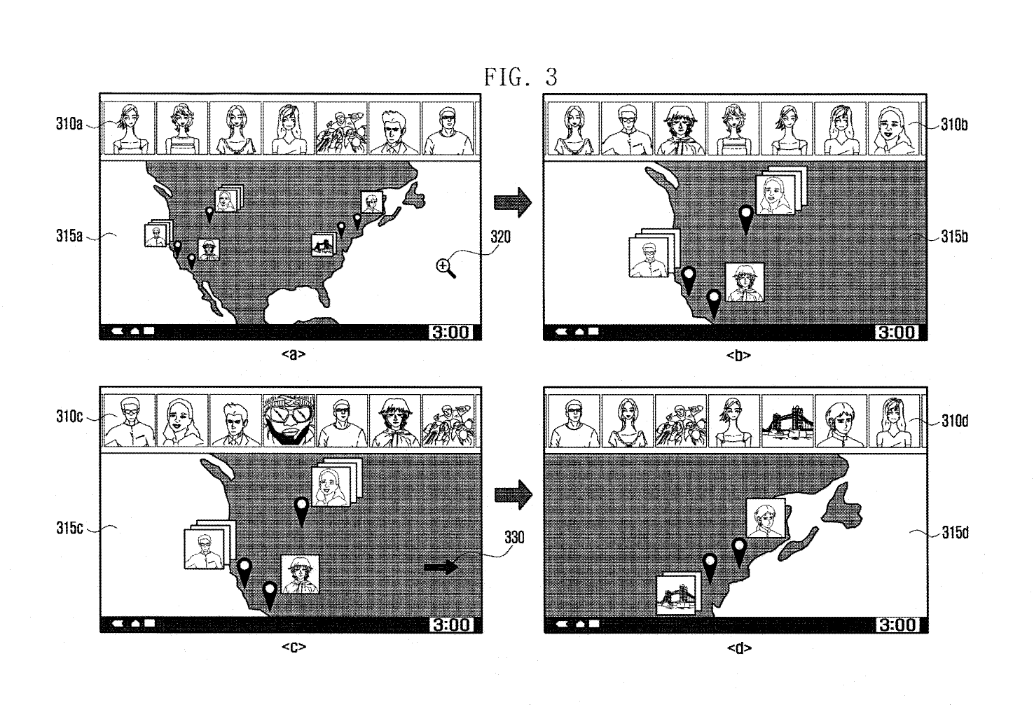

FIGS. 3A to 3D illustrate screens where a mobile device operates in a data display mode according to the first exemplary embodiment of the present invention, according to the occurrence of input events. For example, the filtering condition information displayed on the condition display area is location information. The first exemplary embodiment of the method of the present invention for displaying filtering condition information is explained in such a way that the filtering condition information is displayed on a map image.

As shown in FIGS. 3A to 3D, the display unit 113 displays a data display area for showing one or more items of the media data 135 and a condition display area for showing one or more pieces of filtering condition information 137 in a data display mode. The data display area displays thumbnail images corresponding to the media data 135 including the location information. The condition display area displays a map image as a background image, on which information regarding locations according to the media data 135, as filtering condition information 137, is displayed. The location information includes the coordinates of a corresponding location. Therefore, location information, as filtering condition information 137, is displayed at a corresponding location using coordinates on the map image.

The display unit 113 alters and displays the condition display area showing the filtering condition information 137, according to the presence of events. Examples of the events include an event for selecting conditions, an event for executing a zooming-in/out function or a moving function, and an event for selecting a number of pieces of filtering condition information.

For example, as shown in FIG. 3A, the screen displays a data display area 310a and a condition display area 315a. When an event 320 for executing a zooming-in/out function occurs in the condition display area 315a, the display unit 113 alters the condition display area 315a to be the condition display area 315b, according to the sensed event, as shown in FIG. 3B. That is, if the event for zooming-in on the condition display area 315a occurs, the display unit 113 enlarges the condition display area 315a and re-displays the enlarged condition display area 315b. In that case, one or more thumbnail images, displayed on the data display area 310b, are also altered according to the filtering condition information 137 located in the re-displayed condition display area 315b.

Likewise, as shown in FIG. 3C, the screen displays, for example, a data display area 310c and a condition display area 315c. When a moving event 330 occurs in the condition display area 315c, the display unit 113 alters and re-displays the condition display area 315c to be the re-displayed condition display area 315d, according to the sensed event, as shown in FIG. 3D. That is, if the event for moving the condition display area 315c in the rightward direction occurs, the display unit 113 re-displays the moved condition display area 315d. In that case, one or more thumbnail images, displayed on the data display area 310c, are also altered to be the data display area 310d according to the filtering condition information 137 located in the re-displayed condition display area 315d.

A particular area displayed on the display unit 113 may be used to set the filtering condition information 137 via the processes described above. The media data 135 corresponding to the selected filtering condition information 137 is also displayed, in real-time. Therefore, the user may feel interest or be entertained by such manipulation of images and display areas, as well as viewing the media data 135 and thumbnails of the manipulated images and display areas, during the setting of the filtering condition information 137 and also to view his/her required or selected media data in real-time.

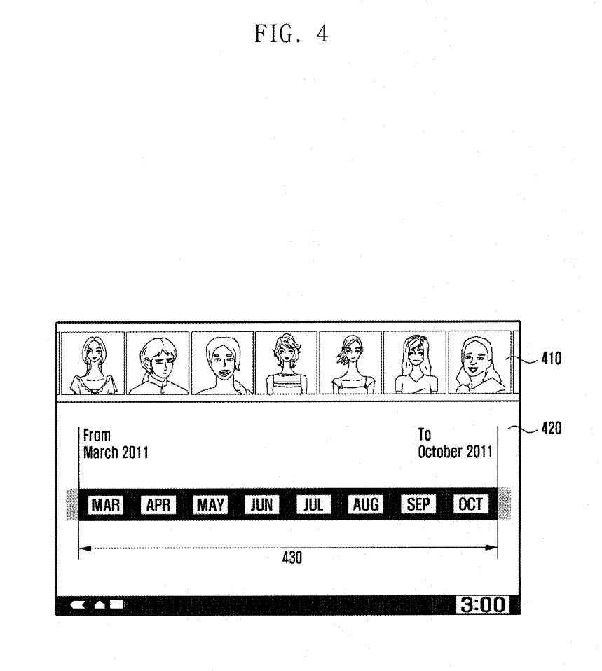

FIG. 4 illustrates a screen where a mobile device operates in a data display mode according to a second exemplary embodiment of the present invention. For example, the filtering condition information 137 displayed on the condition display area is time information. The second embodiment of the method of the present invention for displaying the filtering condition information 137 is explained in such a way that the filtering condition information 137 is displayed on the timeline.

As shown in FIG. 4, the display unit 113 displays a data display area 410 for showing one or more items of the media data 135 and a condition display area 420 for showing one or more pieces of filtering condition information 137 in a data display mode. The data display area 410 displays thumbnail images corresponding to the media data 135 including the time information. The condition display area 420 displays a timeline 430 on which the time information, as filtering condition information 137, is arranged according to the media data 135.

As shown in FIG. 4, pieces of time information for a period of time are arranged on the timeline 430, based on time information when the media data 135 is created. That is, in order to perform a filtering process with respect to media data created between March 2011 and October 2011, corresponding filtering condition information 137 is displayed in respective months. In that case, a particular piece of filtering condition information 137 in the condition display area 420 may be selected according to an event that occurred. Alternatively, filtering condition information 137 in another range may be zoomed-in/out. For example, if an event for executing a zooming-in function occurs, the filtering condition information 137 corresponding to a month displayed on the condition display area 420 is altered to the filtering condition information 137 corresponding to a day. In addition, if an event for executing a zooming-in function re-occurs, the filtering condition information 137 corresponding to a day displayed on the condition display area 420 is altered to instead be filtering condition information 137 corresponding to another time period.

If the filtering condition information 137 is time information, the media data 135 created for a period of time, corresponding to the filtering condition information 137 displayed on the timeline 430 displayed on the condition display area 420, is displayed, as thumbnail images, on the data display area 410. In order to alter the period of time, the user alters the displayed length or area of the timeline 430 displayed on the condition display area 420 by creating an event for executing a zooming function and/or a moving event. The unit of time, displayed according to the enlargement or reduction of the timeline 430, can be altered according to any of an hour/day/month/year. If the user wants to view the media data 135 created for a particular time point, he/she can select corresponding filtering condition information 137 displayed on the timeline 430. In that case, the mobile device performs a filtering process based on the filtering condition information 137, and displays only the filtered media data on the data display area 410.

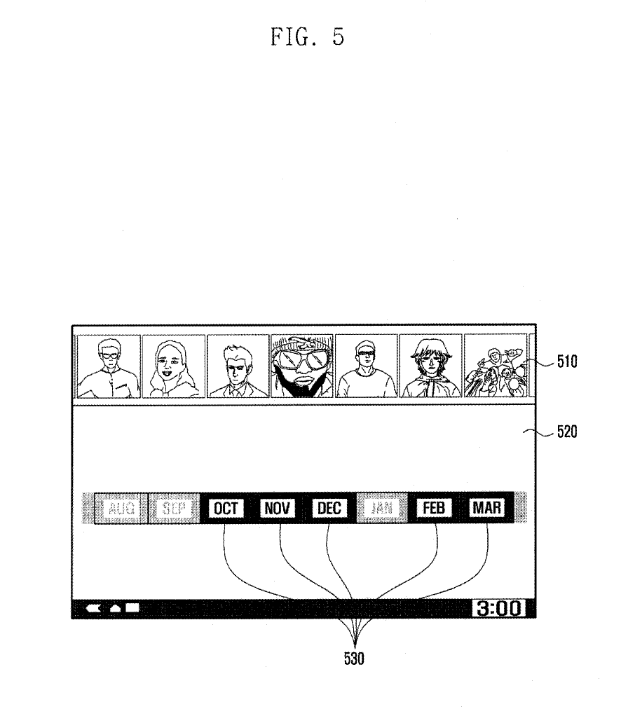

FIG. 5 illustrates a screen where a mobile device operates in a data display mode according to the second exemplary embodiment of the present invention, where a number of filtering conditions are selected.

As shown in FIG. 5, the display unit 113 displays a data display area 510 for showing one or more items of the media data 135 and a condition display area 520 for showing one or more pieces of the filtering condition information 137 in a data display mode. The data display area 510 displays thumbnail images corresponding to the media data 135 including time information. The condition display area 520 displays a timeline on which the time information, as the filtering condition information 137, is arranged. The user can select a number of pieces of the filtering condition information 137 corresponding to the media data 135 that he/she wants to view. That is, as shown in FIG. 5, the user can select only particular filtering condition information 530 from among a number of pieces of filtering condition information 137 displayed in the condition display area 520. In that case, the mobile device can display the selected filtering condition information 530 so that such selected filtering condition information 530 are distinguished from other filtering condition information 137, for example, stored in the storage unit 130. In addition, the mobile device also displays, on the data display area 510, the thumbnail images of the media data 135 corresponding to the selected filtering condition information 530.

Therefore, the user can select only his/her required or selected filtering condition information 530 from among pieces of filtering condition information 137 displayed on the condition display area 520. The mobile device can thus display the media data 135 corresponding to the selected filtering condition information 530, as thumbnail images displayed in the data display area 510.

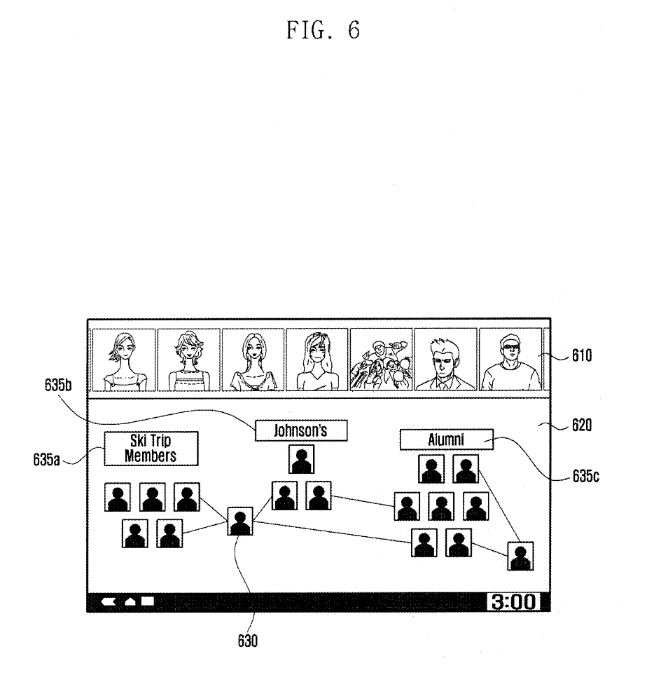

FIG. 6 illustrates a screen where a mobile device operates in a data display mode according to a third exemplary embodiment of the present invention.

As shown in FIG. 6, the display unit 113 displays a data display area 610 and a condition display area 620 in a data display mode. The data display area 610 shows one or more items of the media data 135. The condition display area 620 shows information regarding groups 635a, 635b, and 635c, with respect to information regarding the user represented by an icon 630, with the user being the current user of the mobile device or a different person selected by the user of the mobile device, as one or more pieces of the filtering condition information 137. The locations of the group information 635a, 635b, and 635c may be set on the screen according to the frequency of the user's contacts, for example, with more frequently contacted groups displayed relatively close to the icon 630 of the user, while less frequently contacted groups displayed relatively farther away. Alternatively, the user's contact members are grouped in corresponding groups that the user may set in a communication service or Social Network Service (SNS) and displayed as the groups on the screen of the user's mobile device. For example, the group information 635a, 635b, and 635c may correspond to “Ski Trip Members”, “Johnson's” as members of the Johnson family, and “Alumni” of a specific school associated with the user represented by the icon 630.

The mobile device performs a filtering process with respect to image data related to the group information 635a, 635b, and 635c displayed on the condition display area 620, and displays the results as thumbnail images on the data display area 610. In order to alter the range of filtering condition information, the user zooms in/out or moves the group information 635a, 635b, and 635c on the condition display area 620 using the graphic user interface (GUI) and the touch screen 110 in a manner known in the art, for example, by tapping or dragging and dropping icons associated with respective users in each of the groups represented by the group information 635a, 635b, and 635c.

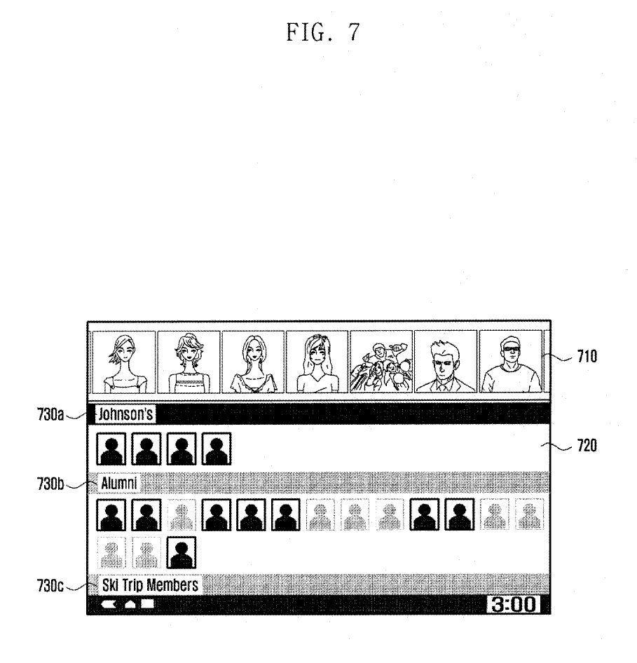

FIG. 7 illustrates a screen where a mobile device operates in a data display mode according to a fourth exemplary embodiment of the present invention.

As shown in FIG. 7, the display unit 113 displays a data display area 710 and a condition display area 720 in a data display mode. The data display area 710 shows one or more items of the media data 135. The condition display area 720 shows information regarding groups 730a, 730b, and 730c, as one or more pieces of filtering condition information 137. The data display area 710 displays thumbnail images corresponding to information regarding the other users included in the group information 730a, 730b, and 730c. The condition display area 720 displays a list of group information 730a, 730b, and 730c, as the filtering condition information 137. That is, the condition display area 720 displays a list of information regarding groups or other users 730a, 730b, and 730c. If information regarding a particular group or user is selected, the image data corresponding to the information regarding a selected group or user is displayed, as a thumbnail image, on the data display area 710. The fourth exemplary embodiment shown in FIG. 7 differs from the third exemplary embodiment shown in FIG. 6, in that the group information 635a, 635b, and 635c is displayed in FIG. 6 in a networking or relational configuration with respect to a user represented by the icon 630, while the group information 730a, 730b, and 730c, which may be identical to the group information 635a, 635b, and 635c, is displayed in FIG. 7 in simple lists such as detail lists without the relational display, with the condition display area 720 being scrollable to show other groups, such as the Ski Trip Members associated with the group information 730c.

Alternatively or in addition, as shown in FIG. 7, the group information 730a, 730b, and 730c may be displayed as icons of all available or known members of such groups. Coloring or other visual effects in the condition display area 720 may be used for visually distinguishing members of groups known to the user of the mobile device from members of groups not known to the user. For example, icons in the condition display area 720 may be grayed out if the user does not know the group member associated with a specific icon, while icons of group members known to the user may be highlighted and/or shown in full color.

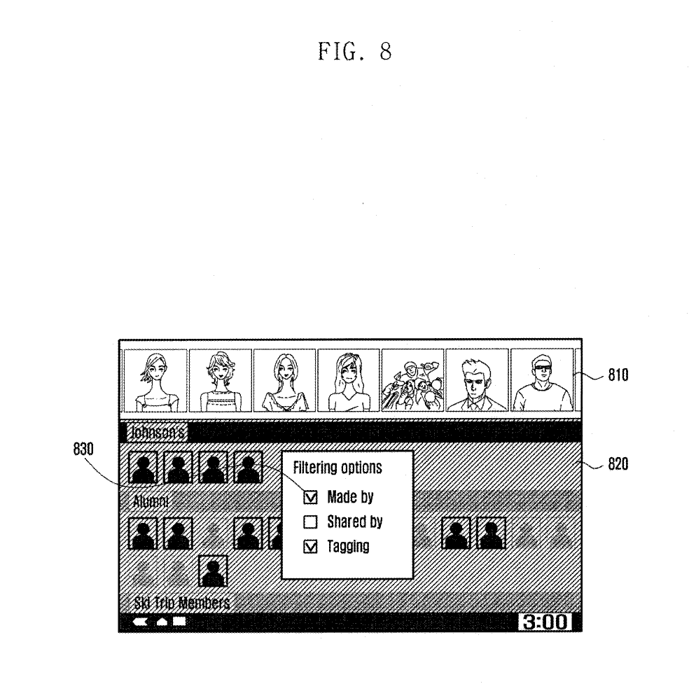

FIG. 8 illustrates a screen where a mobile device operates in a data display mode according to a fifth exemplary embodiment of the present invention, where an additional filtering condition is selected.

As shown in FIG. 8, the display unit 113 displays a data display area 810 and a condition display area 820 in a data display mode. The data display area 810 shows one or more items of the media data 135, in a manner similar or identical to the fourth exemplary embodiment shown in FIG. 7. The condition display area 820 shows information regarding groups as group information, in the form of one or more pieces of filtering condition information 137. The data display area 810 displays thumbnail images of media data corresponding to the group information. The condition display area 820 displays the group information, as filtering condition information 137, in a list.

In response to a predetermined filter command input through the touch screen 110, the controller 120 changes the condition display area 820 on the display unit 113 to display a pop-up window 830 showing a number of pieces of filtering condition information 137 that the user can select. For example, the user can set options such as ‘made by’ to set a person who created media data, ‘shared by’ to set a person who shared media data, and ‘tagging’ to set a person who was tagged in the media data, using menu options displayed on the pop-up window 830.

In the illustrative examples described herein, each of the data display areas displays thumbnail images corresponding to image data, and also information regarding the other users, as the filtering condition information 137. If information regarding one of the other users is selected, the mobile device may display detailed condition information to determine whether the selected information regarding the other user: corresponds to image data created by the mobile device; is image data included in an album allocated to the user; or image data tagged by the user. If the user selects one or more pieces of detailed condition information, the mobile device performs a filtering process, acquires, from the media data 135, any media data satisfying the selected condition information, and displays the acquired media data as thumbnail images on the data display area. Therefore, the user can acquire corresponding media data by combining condition information with each other.

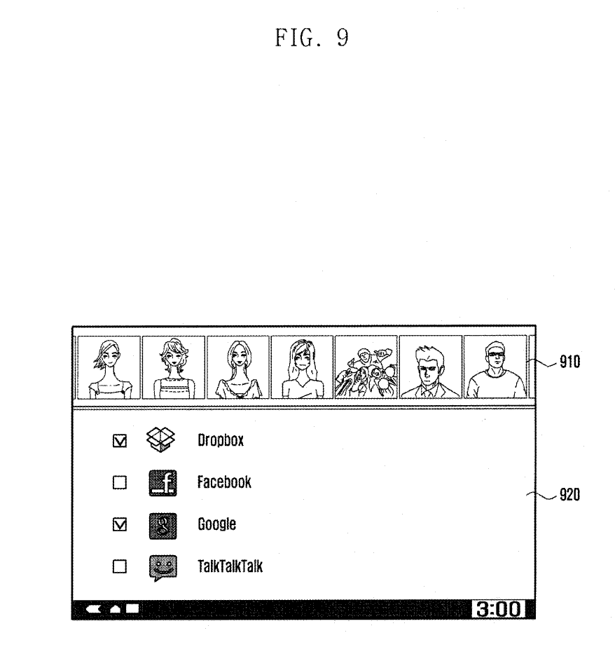

FIG. 9 illustrates a screen where a mobile device operates in a data display mode according to a sixth exemplary embodiment of the present invention.

As shown in FIG. 9, the display unit 113 displays a data display area 910 and a condition display area 920 in a data display mode. The data display area 910 shows one or more items of media data. The condition display area 920 shows service channels, as one or more pieces of filtering condition information 137. The data display area 910 displays thumbnail images of the media data 135 provided via the service channels. The condition display area 920 displays a list of service channels, as the filtering condition information 137.

The mobile device user can select a service channel providing media data. If one of the service channels displayed on the condition display area 920 is selected, the display unit 113 displays thumbnail images corresponding to any of the media data 135, provided via the selected service channel, on the data display area 910.

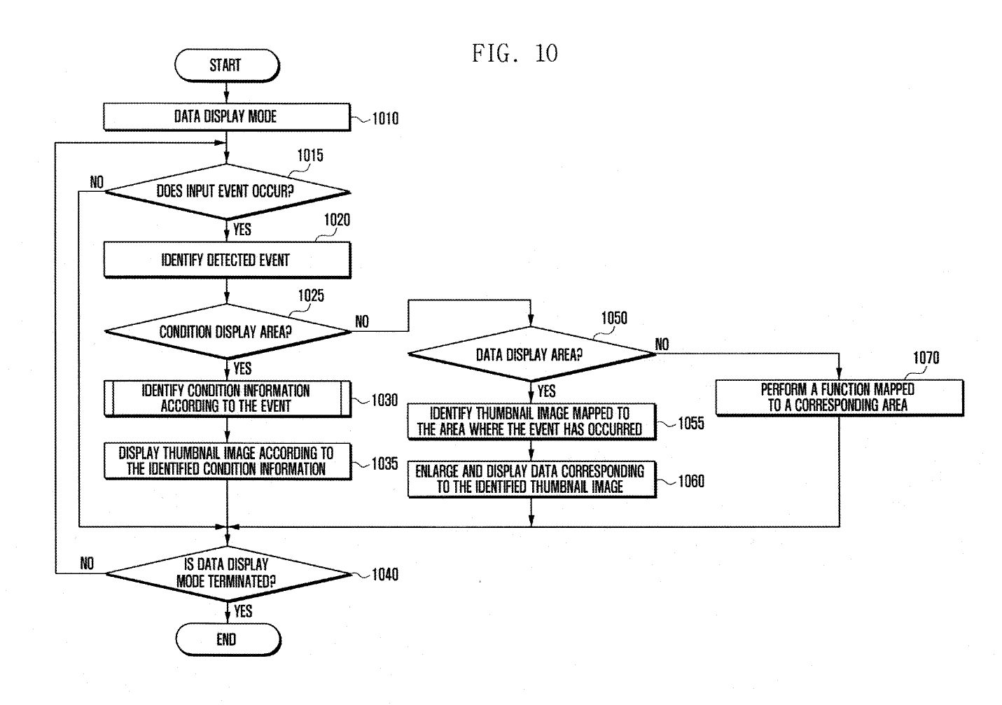

FIG. 10 illustrates a flow chart that describes a method for displaying data, according to the exemplary embodiments of the present invention.

Referring to FIG. 10, the mobile device operates in a data display mode according to the user's selection in step 1010. In the data display mode, the mobile device displays the stored media data 135 according to the filtering condition information 137. Examples of the data display mode includes an image display mode where videos and still images such as photographs, etc., are displayed, a text data display mode where text data, such as documents, etc. are displayed, a message display mode where transmitted/received messages are displayed, etc. During the data display mode, the display unit 113 displays two areas: one is a data display area showing thumbnail images corresponding to the media data 135, and the other is a condition display area showing the filtering condition information 137 to perform a filtering process with respect to the media data 135.

In the data display mode, the mobile device displays the media data 135 and the detailed information regarding the media data 135 on the display unit 113. That is, in an image display mode, the mobile device may display, on the display unit 113, only the media data 135 that includes information regarding a location where the media data 135 is created, according to the user's selection or the manufacturer's settings. During the display process, location information according to the media data 135, as the filtering condition information 137, is also displayed on the condition display area. Alternatively, the media data 135 may be displayed, with respect to a date that the media data is created, on the display unit 113. In that case, the date information by the media data 135, as the filtering condition information 137, is displayed on the condition display area.

The mobile device determines whether an event occurs in step 1015. If the mobile device ascertains that an event occurred at step 1015, the mobile device identifies the area where the event occurred in step 1020. The event may be created when a touch is made on or released from the touch screen 110 or when the direction keys of a physical keypad are operated.

The mobile device determines whether the area where the event occurred is a condition display area in step 1025. If the mobile device ascertains that the area where the event occurred is a condition display area at step 1025, the mobile device identifies the filtering condition information 137 according to the event in step 1030, which will be described in greater detail. Referring back to step 1030, the mobile device zooms-in/out the condition display area or moves the condition display area, according to the event. After identifying the filtering condition information 137 at step 1030, the mobile device displays thumbnail images according to the identified filtering condition information on the data display area in step 1035. That is, the mobile device re-searches for thumbnail images of the media data 135 corresponding to the filtering condition information 137, displayed on the condition display area altered according to the zooming-in/out event or the moving event, and displays the re-searched thumbnail images on the data display area.

After displaying the thumbnail images at step 1035, the mobile device determines whether a command for terminating the data display mode is input in step 1040. If the mobile device ascertains that a command for terminating the data display mode is not input at step 1040, the mobile device proceeds with step 1015. However, if a command for terminating the data display mode is input at step 1040, the method ends.

Referring back to step 1015, if the mobile device ascertains that an event did not occur at step 1015, the mobile device proceeds with step 1040.

Referring back to step 1025, if the mobile device ascertains that the area where the event occurred is not a condition display area, the mobile device determines whether the area is a data display area in step 1050. If the mobile device ascertains that the area where the event occurred is a data display area at step 1050, the mobile device identifies a thumbnail image mapped to the area in step 1055. After that, the mobile device enlarges the media data corresponding to the identified thumbnail image and displays the enlarged media data on the entire screen of the display unit in step 1060. The mobile device then proceeds to step 1040.

Referring back to step 1050, if the mobile device ascertains that the area is not a data display area at step 1050, the mobile device performs a function mapped to the area where the event occurred in step 1070. That is, if the event occurred on the area to which a menu for altering or adding filtering condition information is mapped or a menu for executing the other functions is mapped, the mobile device executes the corresponding function. The mobile device then proceeds to step 1040.

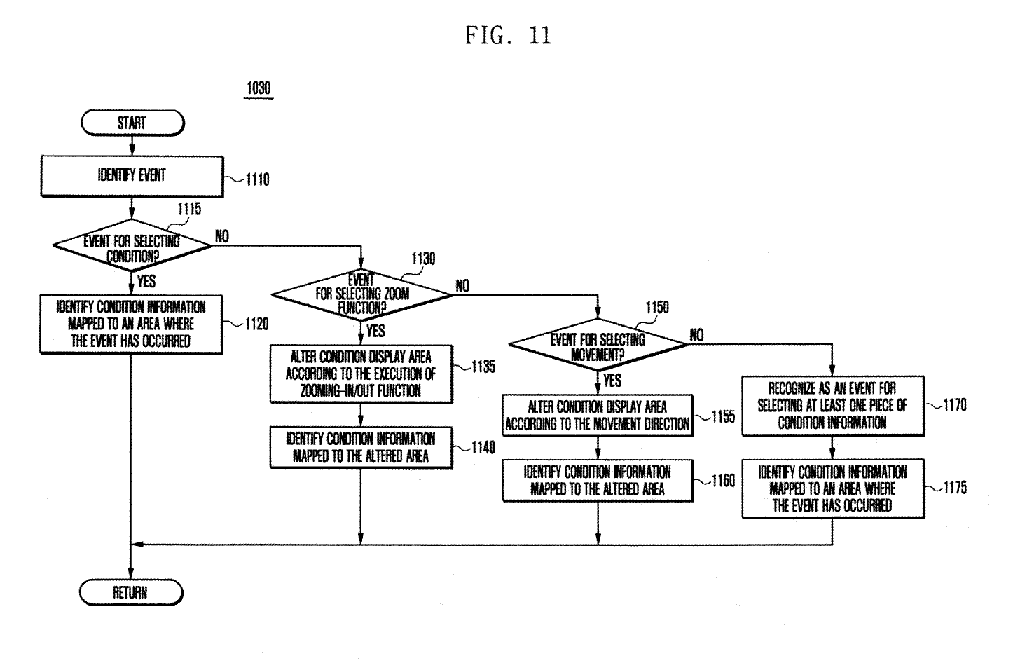

Referring to FIG. 11, the following description explains a method for altering a condition display area showing filtering condition information according to the event, and for identifying a region to which the filtering condition information is mapped, to implement step 1030 in FIG. 10.

FIG. 11 illustrates a flow chart that describes a method for identifying filtering conditions altered according to the occurrence of events, according to the exemplary embodiments of the present invention.

Referring to FIG. 11, the mobile device identifies the event that occurred in step 1110. The mobile device determines whether the event is an event for selecting filtering condition information in step 1115. If the mobile device ascertains that the event is an event for selecting filtering condition information at step 1115, the mobile device identifies the filtering condition information mapped to the area where the event occurred in step 1120. The mobile device performs a filtering process with respect to one or more thumbnail images that meet the identified filtering condition information, displayed on the data display area, and re-displays the thumbnail images on the data display area. The method of FIG. 11 then ends performing step 1030 in FIG. 10, or otherwise the mobile device returns to perform other functions, such as the remaining steps in FIG. 10.

Otherwise, in step 1115, if the mobile device ascertains that the event is not an event for selecting filtering condition information, the mobile device determines whether the event is an event for executing a zoom function in step 1130. If the mobile device ascertains that the event is an event for executing a zooming-in/out function at step 1130, the mobile device alters the condition display area according to the zooming-in/out function in step 1135. That is, the mobile device enlarges or reduces the condition display area according to the event. After that, the mobile device identifies the filtering condition information mapped to the altered condition display area in step 1140, and then the method of FIG. 11 ends performing step 1030. Therefore, the mobile device performs a filtering process with respect to one or more thumbnail images, displayed on the data display area, which meet the filtering condition information mapped to the altered condition display area according to the event for executing the zooming-in/out function, and re-displays the thumbnail images on the data display area.

However, referring back to step 1130, if the mobile device ascertains that the event is not an event for executing a zooming-in/out function at step 1130, the mobile device determines whether the event is an event for moving the condition display area in step 1150. If the mobile device ascertains that the event is a moving event at step 1150, the mobile device alters the condition display area according to the movement direction of the event in step 1155. That is, the mobile device detects the movement direction of the event and then moves the condition display area in the detected movement direction. After that, the mobile device identifies the filtering condition information mapped to the altered condition display area in step 1160, and then the method of FIG. 11 ends performing step 1030. Therefore, the mobile device performs a filtering process with respect to one or more thumbnail images, displayed on the data display area, which meet the filtering condition information altered according to the movement of the condition display area, and re-displays the thumbnail images on the data display area.

However, referring back to step 1150, if the mobile device ascertains that the event is not a moving event at step 1150, the mobile device detects the event as an event for selecting one or more pieces of condition information in step 1170. The mobile device identifies the pieces of condition information in the areas where the events occurred in step 1175, and then the method of FIG. 11 ends performing step 1030. Therefore, the mobile device performs a filtering process with respect to thumbnail images, displayed on the data display area, which meet a number of pieces of filtering condition information selected by the user, and re-displays the thumbnail images on the data display area.

As described above, a particular area displayed on the display unit 113 may be used to set filtering condition information via the processes described above. Media data corresponding to the selected filtering condition information is also displayed, in real-time. Therefore, the user may feel an interest during the setting of filtering condition information and also view his/her required or selected media data in real-time.

Since the invention allows users to intuitively set filtering conditions and displays media data, in real-time, after experiencing a filtering process based on the set filtering conditions, the users can become interested in the process of altering the range of filtering conditions. For example, if a filtering process is performed with respect to media data based on locations, the mobile device can dynamically display the media data, via thumbnail images that are varied according to the enlargement/reduction or movement of the map showing the locations.

As described above, the data display method and the mobile device adapted thereto, according to the invention, can allow users to intuitively select filtering conditions, such as place, time, person, service channel, etc., in order to apply a filtering process to data stored in the mobile device. Since the selected data and the filtering conditions are displayed on one screen of the mobile device, the user can easily identify the data according to the conditions. In addition, since the user can identify data according to the filtering conditions in real time, he/she can set the filtering conditions according to personal preference.

The above-described apparatus and methods according to the present invention can be implemented in hardware, firmware or as software or computer code that can be stored in a recording medium such as a CD ROM, a RAM, a ROM, a floppy disk, DVDs, a hard disk, a magnetic storage media, an optical recording media, or a magneto-optical disk or computer code downloaded over a network originally stored on a remote recording medium, a computer readable recording medium, or a non-transitory machine readable medium and to be stored on a local recording medium, so that the methods described herein can be rendered in such software that is stored on the recording medium using a general purpose computer, a digital computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, the program may be electronically transferred through any media such as communication signals transmitted by wire/wireless connections, and their equivalents.

Although exemplary embodiments of the present invention have been described in detail hereinabove, it should be understood that many variations and modifications of the basic inventive concept herein described, which may be apparent to those skilled in the art, will still fall within the spirit and scope of the exemplary embodiments of the present invention as defined in the appended claims.

What is claimed is:

1. A method for displaying data in a mobile device, comprising:
displaying one or more filtering conditions on a condition display area and one or more items of media data on a data display area in a data display mode;
determining whether an event occurs on the condition display area or the data display area;
identifying, if the event occurred on the condition display area, information regarding a filtering condition as filtering condition information corresponding to the event; and
displaying at least one thumbnail image corresponding to one or more items of media data filtered according to the identified filtering condition information.

2. The method of claim 1, wherein the identification of information regarding a filtering condition comprises:
altering the condition display area according to the type of event; and
identifying the filtering condition information displayed on the altered condition display area.

3. The method of claim 2, wherein the alteration of the condition display area comprises:
zooming-in or out on the condition display area if the event is an event to execute a zooming-in or out function.

4. The method of claim 2, wherein the alteration of the condition display area comprises:
detecting, if the event is a moving event, the direction of movement of the event; and
moving the condition display area according to the detected movement direction of the event.

5. The method of claim 1, wherein the display of the one or more filtering conditions on the condition display area and the one or more items of media data on the data display area comprises:
displaying at least one thumbnail image corresponding to the one or more items of media data including location information on the data display area;
displaying a map image as a background image on the condition display area; and
displaying the location information associated with each of the one or more items of media data, as the filtering condition information, on the map image.

6. The method of claim 1, wherein the display of the one or more filtering conditions on the condition display area and the one or more items of media data on the data display area comprises:
displaying at least one thumbnail image corresponding to the one or more items of media data including time information on the data display area;
displaying a timeline on the condition display area; and
arranging the time information associated with each of the one or more items of media data, as the filtering condition information, on the timeline.

7. The method of claim 1, wherein the display of the one or more filtering conditions on the condition display area and the one or more items of media data on the data display area comprises:
displaying at least one thumbnail image corresponding to the one or more items of media data, including information regarding other users, on the data display area; and
displaying group information including information regarding the other users, as the filtering condition information, on the condition display area.

8. A mobile device comprising:
a touch screen including a display unit and a touch sensor, wherein the display unit displays one or more filtering conditions on a condition display area and one or more items of media data on a data display area in a data display mode, and the touch sensor senses the presence of events that occur on the condition display area or the data display area; and
a controller for identifying an area on the touch screen where a specific event occurs and for controlling, if the area where the specific event occurred is the condition display area, the display unit to display at least one thumbnail image corresponding to one or more items of media data corresponding to the filtering condition information that is altered according to the specific event.

9. The mobile device of claim 8, wherein the controller controls the display unit to alter the condition display area according to the type of the specific event that occurred on the touch screen, and identifies filtering condition information displayed on the altered condition display area.

10. The mobile device of claim 9, wherein the controller controls the display unit to zoom-in or out the condition display area if the specific event is an event to execute a zooming-in or out function.

11. The mobile device of claim 9, wherein the controller detects, if the specific event is a moving event, the direction of movement of the specific event, and move the condition display area according to the detected movement direction of the specific event.

12. The mobile device of claim 8, wherein the controller controls the display unit to display: at least one thumbnail image corresponding to the one or more items of media data including location information on the data display area; a map image as a background image on the condition display area; and the location information associated with each of the one or more items of media data, as the filtering condition information, on the map image.

13. The mobile device of claim 8, wherein the controller controls the display unit to display: at least one thumbnail image corresponding to the one or more items of media data including time information on the data display area; and a timeline on the condition display area, and to arrange the time information associated with each of the one or more items of media data, as the filtering condition information, on the timeline.

14. The mobile device of claim 8, wherein the controller controls the display unit to display: at least one thumbnail image corresponding to the one or more items of media data including information regarding other users on the data display area; and group information including the information regarding the other users, as the filtering condition information, on the condition display area.
